(19) United States
(12) Patent Application Publication
(10) Pub. No.: US 2008/0118012 A1
(43) Pub. Date: May 22, 2008

(54) METHOD AND APPARATUS FOR INTERFERENCE CANCELLATION IN A WIRELESS COMMUNICATION SYSTEM

(75) Inventors: Robert J. Corke, Glen Ellyn, IL (US); Daniel G. Prysby, Sleepy Hollow, IL (US); Michael F. Zeleznik, La Grange Park, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/562,639

(22) Filed: Nov. 22, 2006

(51) Int. Cl. H04B 1/10; H04L 27/28

(52) U.S. Cl. 375/348; 375/346

(57) ABSTRACT

Described is a method and an apparatus for performing the method to cancel interference caused by a windowing function applied to a signal prior to the signal being transmitted in a wireless communication system such as an OFDM system. The apparatus includes receiver apparatus that receives the signal to which the windowing function was applied. The apparatus further includes a processing device coupled to the receiver apparatus, and the processing device obtains (either by generating in substantially real time or retrieving from a storage device coupled to the processing device) a plurality of coefficients that are derived from the windowing function, and applies the coefficients to the received signal to cancel at least a portion of the interference from the received signal.

### TECHNICAL FIELD

The present invention relates to wireless communications and more particularly to a method and apparatus for canceling interference from a received signal, wherein the interference is caused by a windowing function applied to the signal prior to the signal being transmitted.

### BACKGROUND

A variety of services are available for a future generation 4G wireless communication system. These services are continuously evolving to help the users communicate at high data transfer rates. For many of these services the physical layer of the communication system uses multiplexing technology to enable simultaneous transmission, and reception of independent signals. Orthogonal frequency division multiplexing (OFDM) is one of the multiplexing techniques used by the physical layer of the communication system to enable high speed transmission and reception of digital data signals including, but not limited to, digitized text, digitized video and digitized audio. Due to its feasibility for high-speed data transmission, OFDM was selected as the multiplexing encoding scheme used in implementing an over-the-air interface for Wireless Local Area Networks (WLAN) as specified in the Institute of Electrical and Electronics Engineers (IEEE) 802.11a and HIPERLAN/2, 802.16 Broadband Wireless Access (BWA), and Digital Audio Broadcasting (DAB) standards in the field of wireless communications, and for Asymmetric Digital Subscriber line (ADSL) and Very high-data rate Digital Subscriber Line (VDSL).

OFDM is a modulation technique for transmission based upon the concept of frequency division multiplexing (FDM), wherein each frequency channel is in essence a “sub-channel” that carries a separate stream of data across a communication channel that comprises a plurality of the sub-channels. For each modulation scheme, serial bits comprising the digitized data are encoded to generate a plurality of modulation symbol streams that modulate a plurality of subcarriers at different frequency offsets from a carrier frequency. An OFDM symbol stream modulated onto at least one subcarrier represents a sub-channel. In OFDM, the subcarrier frequencies are chosen such that they are orthogonal to each other, which allows high spectral efficiency.

OFDM modulation and demodulation are typically implemented using digital filter banks using Fast Fourier Transform (FFT). A transmitted OFDM symbol's time domain sample sequence is generated from a set of subcarrier modulation symbols by carrying out an Inverse Discrete Fourier Transform, usually implemented as an Inverse Fast Fourier Transform (IFFT), on the sequence of subcarrier modulation symbols. More particularly, after the sequence of serial bits are converted to a sequence of subcarrier modulation symbols associated with the set of subcarriers, a time domain sample sequence is generated from the inverse DFT of the subcarrier modulation symbol sequence.

In order to meet a spectral emission mask specification, which may be quite severe (e.g. the DSRC class C and M masks), a non-rectangular window (or windowing) function is applied to the time domain sample sequence (note, a rectangular window function amounts to no applied window function). The application of the windowing function is a sample-by-sample multiplication of the windowing function and the time domain sample sequence. This results in interference from inter-tone interference (ITI) and inter-symbol interference (ISI), which reduces the maximum achievable carrier-to-interference (C/I) ratio and which in turn translates to a reduction in receiver sensitivity. In other words, at a certain threshold, ITI and ISI decreases the C/I ratio to a point as to compromise the integrity of the received data. Accordingly, if the maximum achievable C/I is less than that required for a given data rate (i.e., modulation and coding scheme), that rate is not supportable for data transmission. Moreover, in some cases the maximum achievable C/I may be les than that required for even the lowest modulation and coding rate, thereby, making the channel unusable.

More specifically, the application of the window function modifies the original time domain sample sequence of a given OFDM symbol in two ways. First, weighted time domain samples from OFDM symbols adjacent (prior and/or subsequent) to the current OFDM symbol are added to a portion of the time domain samples of the current OFDM symbol, and second, a portion of the current OFDM symbol's time domain sample sequence is modified or weighted according to the applied window function. As a result, the transmitted time domain sample sequence for the current OFDM symbol contains time domain samples from the current OFDM symbol, some of which have been modified, as well as weighted samples from adjacent OFDM symbols.

The receiver, attempts to recover the original subcarrier modulation symbols from the received OFDM symbol's time domain sample sequence by correlating, via a DFT, the received sample sequence with each orthogonal subcarrier. Ideally, a transmitted OFDM time domain sequence is the sum of orthogonal subcarriers (sine waves or tones), where each subcarrier is weighted by its associated modulation symbol. In order for the weighted subcarriers to remain orthogonal, the periodicity of each subcarrier must be preserved for the entire correlation period or equivalently the entire DFT time. However, applying different weights to a portion of the time domain sample sequence generated from the weighted subcarriers (as does the windowing function) destroys the periodicity of the subcarriers within the correlation period, which in turn destroys the orthogonality between the subcarriers. As a result, correlation of the received time domain sample sequence with a particular desired subcarrier (sine wave) yields energy from other subcarriers in addition to the desired subcarrier, resulting in the ITI. ISI results from the presence of time domain samples of adjacent (in time) OFDM symbols in the current OFDM symbol's time domain sample sequence to be processed. That is, inclusion of time domain samples from adjacent OFDM symbols in the sequence to be correlated (DFTed), results in weighted subcarrier modulation symbols from the adjacent OFDM symbols as well as from the current OFDM symbol.

Further adding to the problem at the receiver end is that the received signal can be notably distorted when the transmitted signal reaches the receiver with different delay times over different paths, which is known in the art as multipath fading and is in practice due, for example, to reflections of radio signals against objects (such as mountains and buildings). This distortion also causes ISI as is manifested due to the temporal spreading and consequent overlap of individual pulses to a degree that a receiver cannot reliably distinguish between individual OFDM symbols, which (as discussed above) reduces the maximum attainable C/I ratio resulting in decreased receiver sensitivity.

To avoid ISI under multipath fading conditions, a guard time interval is inserted prior to an OFDM block or OFDM symbol. During this interval, a cyclic prefix is transmitted to provide a buffer for the overlap of adjacent OFDM symbols due to multipath conditions. The cyclic prefix is usually a copy of the last portion of the OFDM symbol (e.g., the D samples) prepended to the front of the OFDM symbol. For proper implementation (or ideally to attain sufficient maximum attainable C/I to support all possible data rates), the length of the cyclic prefix should exceed the maximum path delay. However, this is not practical in many instances for a number of reasons. First, the maximum path delay varies from place to place and from time to time making it difficult to design a system that could adaptively adjust the number of cyclic prefixes to accommodate all possible data rates. Second, even is the number of cyclic prefixes could be sufficiently increased, it would be at the expense of spectral efficiency since the addition of cyclic prefixes reduces the spectral efficiency of the system. Furthermore, increasing the number of cyclic prefixes does not address the ITI and ISI introduced by the addition of a non-rectangular windowing function at the transmitter, which reduces the amount of tolerable channel delay spread thereby, reducing the effective guard interval provided by the cyclic prefixes.

Thus, what is needed is a technique for cancelling (which herein means reducing) the ISI and/or ITI caused by application of a non-rectangular windowing function to a signal prior to its transmission.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication system, wherein embodiments of the invention can be implemented.

FIG. 2 is a block diagram of portions of a transmitting device used in the system of FIG. 1.

FIG. 3 illustrates a sequence of OFDM symbols with a windowing function applied to the symbols prior to transmission.

FIG. 4 is a block diagram of portions of a receiving device used in the system of FIG. 1, which is configured for cancelling interference from the signal of FIG. 3 in accordance with embodiments of the invention.

FIG. 5 is a flow diagram illustrating of a method of interference cancellation from a received signal in accordance with embodiments of the invention.

FIG. 6 illustrates a sequence of OFDM symbols with an alternative windowing function applied to the symbols prior to transmission.

FIG. 7 is an expanded block diagram of the receiving device of FIG. 4.

FIG. 8 is a flow diagram illustrating a method of interference cancellation from a received signal in accordance with embodiments of the invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for interference cancellation in a wireless communication system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that the embodiments of the invention described herein may be comprised of one or more generic or specialized processors (or “processing devices”) such as microprocessors, digital signal processors (DSPs), customized processors and field programmable gate arrays (FPGAs) and unique stored program instructions (including both software and firmware) that control the one or more processors to implement, in conjunction with certain non-processor circuits, some, most, or all of the functions of the method and apparatus for interference cancellation in a wireless communication system described herein. The non-processor circuits may include, but are not limited to, a radio receiver, a radio transmitter and user input devices. As such, these functions may be interpreted as steps of a method to perform interference cancellation in a wireless communication system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Moreover, it will be appreciated that the embodiments of the invention described herein may be used for cancellation of interference in any wireless communication system that applies a window function to the transmitted signal, especially in multiple access systems where a shared resource can be divided in such a way as to enable simultaneous use of the shared resource by multiple users. Further it is expected that a person of ordinary skill in the art will realize that the interference cancellation method and apparatus described herein can be used with any modulation scheme including, but not limited to, Binary Phase-Shift Keying (BPSK), Quadrature Phase-Shift Keying (QPSK), Minimum-Shift Keying (MSK), Offset Quadrature Phase-Shift Keying (OQPSK), Quadrature Amplitude Modulation (QAM), etc.

Generally speaking, pursuant to the various embodiments, the invention describes methods and an apparatus for interference cancellation in a wireless communication system. For example in a multiple access communication system, such as an OFDM system, a time domain window function is often applied in a transmitting device to a transmitted signal sample sequence, to meet a spectral emissions mask. The application of a time domain window function to the sample sequence causes interference in the form of inter-symbol interference (ISI) and inter-tone interference (ITI). The invention discloses a method used in a receiving device to cancel this interference from the received signal sample sequence and to, thereby, increase receiver sensitivity and the maximum achievable C/I ratio. The invention applies coefficients, which are derived from the window function, to the received signal sample sequence to perform the interference cancellation.

In an embodiment, derived coefficients representing a channel impulse response between the transmitting device and the receiving device are further applied to the received signal sample sequence to perform the interference cancellation. The plurality of coefficients may be determined instantaneously, determined a priori and stored in a memory in the receiving device or a combination of both, depending on processing and memory constraints in the receiving device. The coefficients that are derived from the window function are derived under varying conditions of multipath delay.

In an OFDM system, these derived coefficients are applied to a plurality of regenerated subcarrier modulation symbols for a current and at least one adjacent OFDM symbol to produce an estimated interference value for each received subcarrier's modulation symbol of the current OFDM symbol. The corresponding estimated interference value is subtracted from each received subcarrier's modulation symbol of the current OFDM symbol to at least in part cancel the interference caused by application of the window function. The cancellation of interference from the received OFDM symbols is performed in the frequency domain, thereby, requiring less complex processing. Those skilled in the art will realize that the above recognized advantages and other advantages described herein are merely exemplary and are not meant to be a complete rendering of all of the advantages of the various embodiments of the present invention.

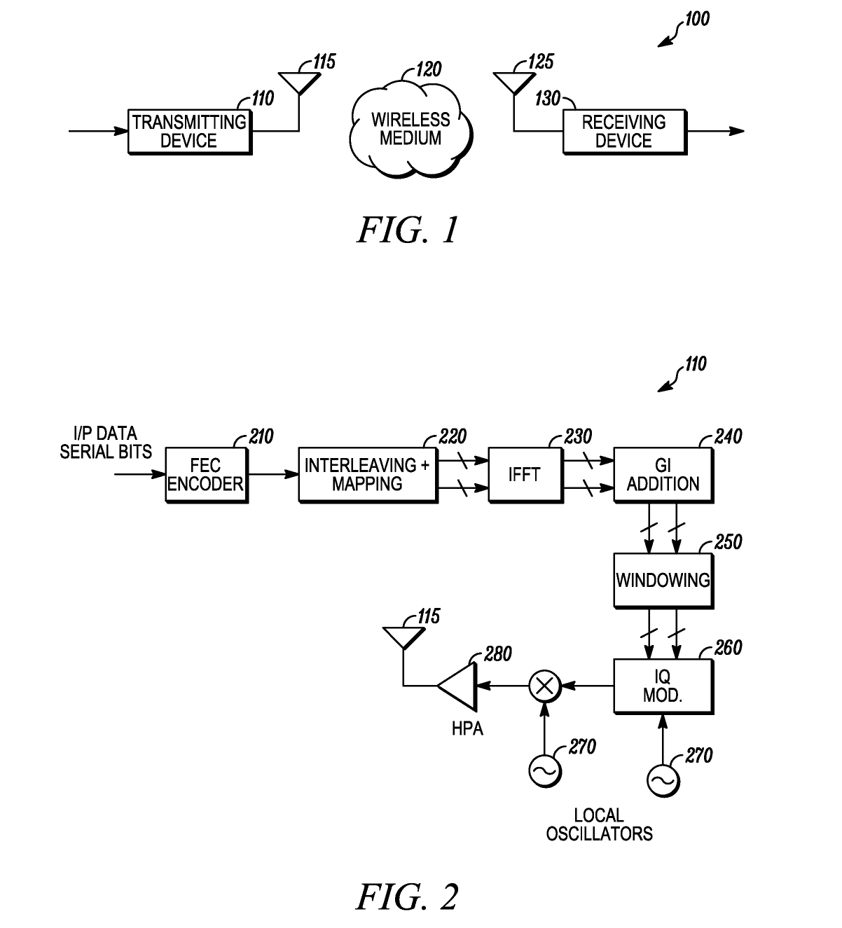

Referring now to the drawings, and in particular FIG. 1, a block diagram of a wireless communication system, wherein embodiments of the present invention can be implemented is shown and generally indicated at 100. System 100 comprises a plurality of communication devices (e.g., a transmitting device 110 and a receiving device 130) communicating via a wireless medium 120. Wireless medium, 120 consists of one or more propagation radio frequency (RF) channels within a designated frequency band across which the communication devices communicate.

Each communication device comprises at least a processing device (not shown), e.g., a DSP, for processing a digitized data signal including modulating or demodulating the data signal onto or off of one or more carrier signals. Each communication device further comprises transceiver apparatus (including both transmitting and receiving apparatus, also referred to in the art as radio front-end apparatus) that usually includes a power amplifier, one or more filters, an equalizer, a duplexer, and an antenna (e.g. antenna 115 in transmitting device 110 and antenna 125 in receiving device 130) to transmit and receive the modulated signal. Moreover, the communication devices further comprises additional elements as are needed in a commercial embodiment including, but not limited to, memory, user input devices, display devices, analog-to-digital and digital-to-analog converters, and the like. The communication devices may be, for instance, portable or mobile radios, laptops, Personal Digital Assistants, etc.

System 100 can be any wireless communication system. However for purposes of describing embodiments herein, system 100 is an OFDM system, wherein the communication devices use the OFDM multiplexing technique to enable the data communications. In one implementation, the communication devices (including devices 110 and 130) are operable in accordance with the IEEE 802.11a and/or 802.16 standards described above and can use a number of modulation schemes including, but not limited to, BPSK, QPSK, 16 QAM and 64 QAM. Moreover, although only two communication devices are shown for ease of illustration, typically system 100 comprises many more communication devices.

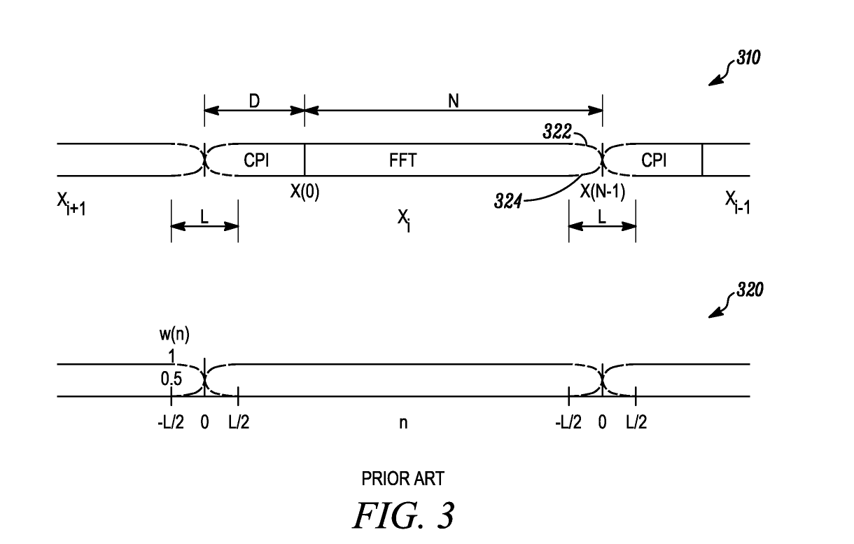

As mentioned above, in an OFDM system a transmitting device (e.g., device 110) may apply a window function to an OFDM signal prior to signal transmission in order to meet a spectral transmission mask specification. This communication paradigm is described next by reference to FIGS. 2 and 3. FIG. 2 illustrates a block diagram of those portions of transmitting device 110 used in processing a digitized signal and transmitting the signal to communication device 130. Accordingly, transmitting device 110 comprises a forward error correction (FEC) encoder 210, an interleaving and mapping processing module 220, an Inverse Fast Fourier Transform (IFFT) processing module 230, a guard interval insertion module 240, a windowing module 250, an Inphase/Quadrature (IQ) modulator 260, local oscillators 270, a high powered amplifier 280 and the antenna 115.

To generate one OFDM symbol (e.g., Xᵢ in FIG. 3), FEC encoder 210 uses forward error correction coding (e.g., convolution coding) to code serial bits of data at a coding rate of ½, ⅔, or ¾ to enable a receiving device to detect and correct errors in the received signal without having to request additional information or data from the transmitting device. Module 220 receives the encoded bits and functionally divides them into M number of parallel bit streams (depending on the modulation scheme selected). Within each parallel bit stream, reordering of bits is performed according to a predefined rule using an interleaver, to guard against burst errors in the transmitted signal. The ordered bits in each parallel bit stream are then mapped into points on an IQ plane based on an m-ary symbol constellation (depending on the modulation scheme selected) and modulated onto a corresponding subcarrier. This generates for each of M number of subcarriers a sequence of subcarrier modulation symbols.

IFFT 230 performs an inverse DFT (using an inverse FFT algorithm) to generate a time domain OFDM symbol sequence that is essentially a summation of the M orthogonal modulated subcarriers at their various offset frequencies (from a carrier frequency). Module 240 repeats a last portion of this OFDM symbol at the beginning of the OFDM symbol (i.e., the cyclic prefix), thus forming a Guard Interval (GI) on the OFDM symbol. The length of the cyclic prefix corresponds to a guard interval time selected to minimize ISI. Although not shown, pilot and/or synchronization symbols are usually inserted into at least some of the subcarrier modulation symbols streams to assist the receiving device with timing synchronization in recovering the transmitted signal and to enable the receiving device to estimate the effect of the channel (e.g., magnitude and phase distortion) on the transmitted signal.

As stated above, in order to meet a specified spectral emission mask, windowing block 250 applies a time domain window function to the time domain sample sequence of the OFDM symbol, which unfortunately destroys the orthogonality between the subcarriers and mixes portions of adjacent OFDM symbols together close to the edges of the time domain sample sequence of the OFDM symbol. Usually the output of block 250 is converted to an analog baseband signal via one or more digital to analog converters (not shown) to generate a baseband signal waveform. IQ modulator 260 upconverts this baseband signal to a radio frequency (RF) signal at the carrier frequency, which is generated by the local oscillators 270. HPA 280 amplifies the RF signal, which is transmitted via antenna 115.

FIG. 3 illustrates a sequence 310 of OFDM symbols in time after modification (i.e. weighting and overlap) by the window function as shown in graph 320. In this illustration, Xᵢ is a current OFDM symbol having two adjacent OFDM symbols, wherein Xᵢ₋₁ is a previous OFDM symbol in time, and Xᵢ₊₁ is a next OFDM symbol in time. In this implementation, the window function w(n) is one suggested for use in the IEEE 802.11a and 802.16 standards and is defined in equation (1) as:

$$\begin{matrix}w ( n ) = {sin}^{2} [ \frac{π}{2} ( \frac{1}{2} + \frac{n}{L} ) ] ; - \frac{L}{2} < n < \frac{L}{2} \\ = 1 ; \frac{L}{2} \leq n < ( N + D ) - \frac{L}{2} \\ = {sin}^{2} [ \frac{π}{2} ( \frac{1}{2} - \frac{( n - ( N + D ) )}{L} ) ] ; ( N + D ) - \frac{L}{2} \leq n < ( N + D ) + \frac{L}{2} ,\end{matrix} \qquad ( 1 )$$

where N is the number FFT samples, D is the number of cyclic prefix samples, L is the number of samples comprising a transition region between two OFDM symbols, and n is a sample index. As can be seen from the OFDM symbol sequence 310 in FIG. 3, an OFDM symbol (e.g., Xᵢ) comprises N+D samples, and the total length of the window to which w(n) is applied is N+L+D. Moreover as can be seen from the sample in sequence 310, in accordance with w(n) in equation (1), the samples outside of the window transition region are not weighted (or weighted with one as the multiplying factor is one). However, the weighting factor caused by w(n) is other than one within each transition region L.

The interference, ITI and ISI, induced on OFDM symbol Xᵢ can be seen from the sample sequence 310. Firstly, note that last L/2 samples 322 of OFDM symbol, Xᵢ, are weighted by the non-unity values of the window function, resulting in a loss of orthogonality among the subcarriers of OFDM symbol Xᵢ, which in turn is manifested as ITI. The same is true for the first L/2 samples of the cyclic prefix interval (CPI) samples, if the receiver includes any of these samples in the FFT (i.e. the receiver timing is advanced). Secondly, note that each of the first and last L/2 (weighted) samples of symbol Xᵢ are pairwise summed with L/2 weighted samples 324 from symbols Xᵢ₊₁ and Xᵢ₋₁, respectively. This results in ISI since any samples from adjacent OFDM symbols that are included in the FFT processing of symbol Xᵢ will result in interference from subcarriers of the adjacent OFDM symbols.

It should be noted that the teachings herein do not depend on the windowing function applied in the transmitting device, but are applicable when any type of windowing function is used including, but not limited to, a Hamming window, a Hanning window, a Bartlett window, a Blackman window, a Kaiser window, etc., is applied to a sequence of the OFDM time domain samples.

As stated above, the maximum attainable C/I ratio associated with the transmitted OFDM symbols is decreased in the presence of the ITI and ISI caused by using the windowing function w(n). It can be shown that maximum attainable average signal power to interference power, C/I, for a k^{th} subcarrier after applying the window function defined by equation (1) for a channel with maximum path delay D can be expressed as equation (2):

$${[ C / I ]}_{k} = \frac{\begin{matrix}{\sum }_{p = 0}^{D - \frac{L}{2}} E {\{ {\vert {h}_{p} \vert}^{2} \} [ N + {γ}_{1 , p} ]}^{2} + \\ {\sum }_{p = D - \frac{L}{2} + 1}^{D} E \{ {{\vert {h}_{p} \vert}^{2} [ N + {γ}_{2 , p} ]}^{2}\end{matrix}}{\begin{matrix}{\sum }_{p = 0}^{D - \frac{L}{2}} E \{ {\vert {h}_{p} \vert}^{2} \} [ 2 {\sum }_{m \neq k}^{ } {\vert {β}_{k , 1 , p} ( m ) \vert}^{2} + {γ}_{1 , p}^{2} ] + \\ {\sum }_{p = D - \frac{L}{2} + 1}^{D} E \{ {\vert {h}_{p} \vert}^{2} \} [ 2 {\sum }_{m \neq k} {\vert {β}_{k , 2 , p} ( m ) \vert}^{2} + {γ}_{2 , p}^{2} ]\end{matrix}} \\ \text{where} , \\ {γ}_{1 , p} = {\sum }_{n = N + D - v + 1}^{N - p + D - 1} [ w ( n ) - 1 ] ; v = \frac{L}{2} + δ ( L ) \\ {γ}_{2 , p} = {\sum }_{n = D - p}^{\frac{L}{2}} [ w ( n ) - 1 ] , \qquad ( 2 )$$

hₚ, represents the complex channel coefficient of the propagation path having delay equal to p samples so that E{|hₚ|²} represents the average power of the p^{th} path where E { } is the expectation operator; m is a subcarrier index; and the β coefficients (which are explained in additional detail below) result from the derivation of the interference (both ISI and ITI) caused by applying the windowing function at the transmitter. More particularly, in an embodiment, β_{k,i,p} (m), (i=1, 2) represent the interference due to the m^{th} subcarrier on the k^{th} subcarrier for the p^{th} propagation path and are derived from the particular windowing function used.

The degradation in C/I has been verified via simulation. For example, simulations have shown that in one case the maximum attainable C/I over a single fixed path declined abruptly from infinity (no interference) to 50 dB based on a transition length L of two samples. The reduction in the maximum attainable C/I results in a reduction in receiver sensitivity. Furthermore, if the resulting maximum attainable C/I is lower than the minimum required C/I for any modulation scheme, that modulation scheme cannot be used.

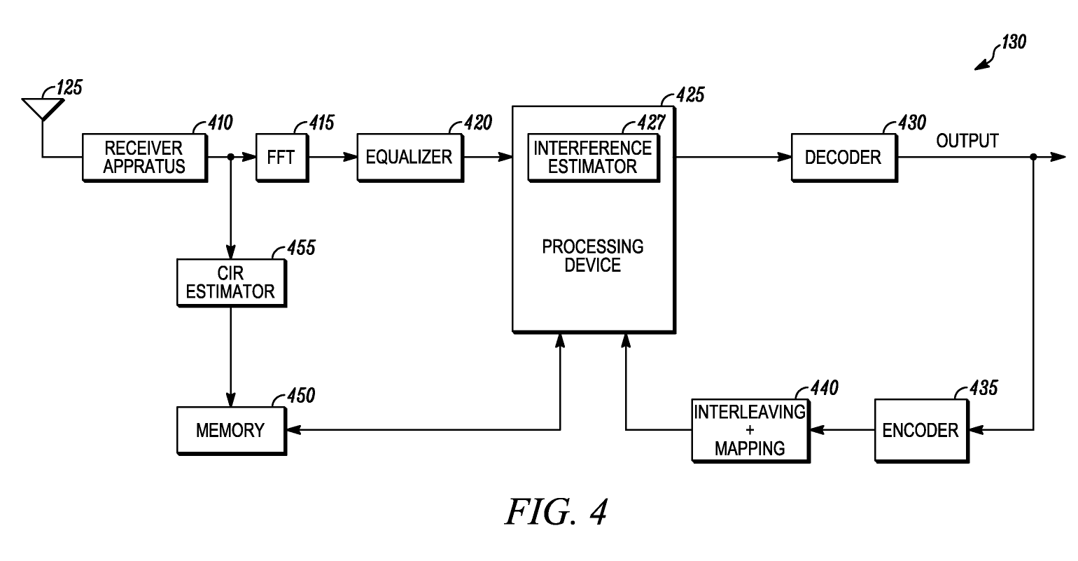

FIG. 4 illustrates a block diagram of those portions of receiving device 130 used in receiving an RF signal transmitted by a transmitting device (e.g., an RF signal comprising OFDM symbols Xᵢ₋₁, Xᵢ and Xᵢ₊₁ that is transmitted by device 110) and processing the signal to obtain the digitized data bits included therein. Essentially, the receiving device performs the inverse operations of the transmitting device to recover those bits. Accordingly, receiving device 130 comprises the antenna 125, receiver apparatus 410, an FFT processing module 415, an equalizer 420, a processing device 425 comprising an interference estimator 427, a forward error correction (FEC) decoder 430, an encoder 435, an interleaving and mapping processing module 440, a Channel Impulse Response (CIR) estimator 455 and a memory 450.

Receiving device 130 receives the RF signal comprising the OFDM symbol sequence 310 at the antenna 125 and passes the signal to the receiver apparatus 410. Receiver apparatus 410 comprises elements such as, for instance: a preselector filter that can be a simple band pass filter designed to pass a desired signal and reject spurious out-of-band signals; a downconverter to downconvert the received signal from RF to baseband frequencies; and an analog to digital converter to sample and digitize the received signal, thereby, generating the time domain OFDM symbol sequence 320.

The digitized time domain OFDM signal sequence is received into FFT module 415 and CIR estimator 455. FFT module 415 performs a DFT (using a FFT algorithm) to transform the time domain sample sequence of the OFDM symbol into a frequency domain sample sequence of subcarrier modulation symbols. Equalizer 420 compensates for the effects of the propagation channel (e.g., magnitude and phase distortion) on the received subcarrier modulation symbol sequence. Processing device 425 can be a DSP (or some other type of processing device such as one described above) and provides, typically among other functions, the interference estimator 427 functionality to cancel interference from the received OFDM symbols, which was caused by applying the window function to the transmitted signal. It should be noted that FIG. 4 illustrates only the interference estimator function 427 being executed by the processing device 425. However, a processing device in the receiving device is not so limited and may in fact (and usually does) execute additional functionality including, but not limited to, additional processing modules not shown as well as those shown in FIG. 4, e.g., FFT module 415, CIR estimator, decoder 430, encoder 435 and interleaving and mapping module 440 without departing from the scope of the teachings herein.

Decoder 430, which in this embodiment is a conventional FEC decoder, generates serial output bits that are ideally substantially those that were transmitted by the transmitting device. These serial output bits can, for example, be put into one or more output formats for a user of the receiving device to see via a display device or to hear via a speaker. The decoded bits are further processed by encoder 435 and interleaving and mapping module 440 in substantially the same manner as the modules 210 and 220, respectively, in the transmitting device shown in FIG. 2. Modules 435 and 440, as will be seen later, are used to generate subcarrier modulation symbols that are used by the interference estimator.

Finally, the CIR estimator 455 uses pilot and perhaps data subcarrier modulation symbols (in a decision directed channel estimator) in a known way to estimate the effects of the propagation channel on the received signal (i.e., to estimate the impulse response of the channel). Based on the results of the CIR estimator 455, CIR coefficients are selected from memory 450 and provided to processing device 425 for interference estimation. Memory 450 could be a Random Access Memory (RAM), Read-Only Memory (ROM) or a combination of one or more different or same kind of memory modules.

Memory 450 also, in one embodiment, stores the β coefficients mentioned above that are used by the interference estimator 427 to mitigate the interference caused by applying the window function to the transmitted signal. Those of ordinary skill in the art will realize that any information that enables the estimation of the ISI and/or ITI caused by w(n) can be stored in the memory 450. It should be further noted that in this embodiment, the β coefficients and information used for interference estimation (are determined a priori and stored in memory 450, for example, in the form of a look-up table. However in other embodiments, these coefficients (and information) can be determined and used instantaneously in some type of adaptive manner as a signal is received, or a combination of both the a priori and adaptive methods depending on the memory and/or processing constraints of the receiving device.

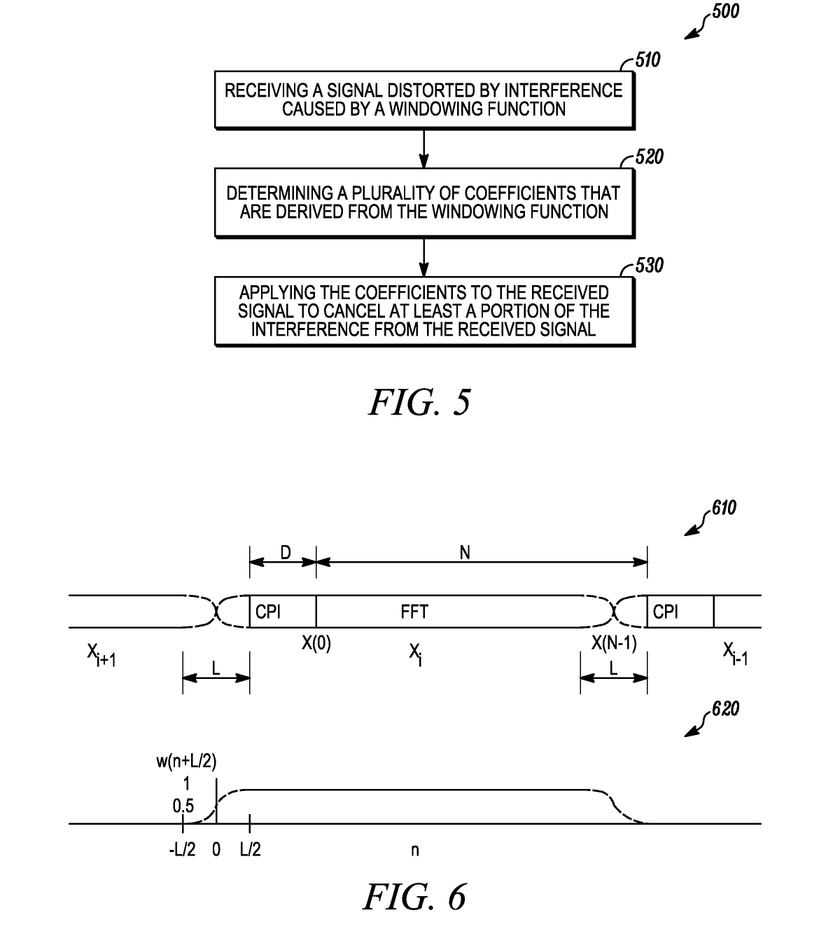

FIG. 5 illustrates a flow diagram illustrating a method of interference cancellation from a received signal (e.g., comprising a plurality of OFDM symbols) in accordance with embodiments of the invention. In general, the method comprises the steps of: receiving (510) a signal that is distorted by interference caused by a windowing function applied to the signal prior to it being transmitted; determining (520) a plurality of coefficients that are derived from the windowing function; and applying (530) the coefficients to the received signal to cancel at least a portion of the interference from the received signal.

In an embodiment, the coefficients that are applied to the received signal to cancel the window-induced interference are the β coefficients and, usually the CIR coefficients. The β coefficients are derived from the windowing function. Moreover, in an embodiment, which is described in detail below by reference to FIGS. 6 through 8, applying the coefficients to the received signal further comprises the steps of: decoding a plurality of OFDM symbols to generate decoded bits; processing the decoded bits to provide regenerated subcarrier modulation symbols for each of the plurality of OFDM symbols; modifying the regenerated subcarrier modulation symbols with the coefficients to estimate the interference; and subtracting the interference from each subcarrier's modulation symbol of a current OFDM symbol.

Where the transmitting device uses w(n) as defined in equation (1), it was shown in FIG. 3 that the current OFDM symbol is subject to ISI from both the previous and subsequent OFDM symbols making interference cancellation complex as can be seen by the following derivations. Let the expressions for the window-induced interference over paths having a channel path delay of p be,

$$\begin{matrix}{I}_{tot} = {I}_{tot , 1} + {I}_{tot , 2} \\ \text{where} & ( 3 ) \\ {I}_{tot , 1} = {\sum }_{p = 0}^{D - \frac{L}{2}} {ITI}_{p} + {\sum }_{p = 0}^{D - \frac{L}{2}} {ISI}_{p} & ( 4 ) \\ {I}_{tot , 2} = {\sum }_{p = D - \frac{L}{2} + 1}^{D} {ITI}_{p} + {\sum }_{p = D - \frac{L}{2} + 1}^{D} {ISI}_{p} \\ \text{and} \\ \text{for} 0 \leq p \leq D - \frac{L}{2} & ( 5 ) \\ {ITI}_{p} = \frac{1}{N} {h}_{p} {\sum }_{m \neq k} {X}_{i} ( m ) {β}_{k , 1 , p} ( m ) & ( 6 ) \\ {ISI}_{p} = \frac{1}{N} {h}_{p} {\sum }_{m ∀ subcarrier s} {X}_{i - 1} ( m ) {e}^{- j2π ( \frac{Dm}{N} - \frac{1}{2} )} {β}_{k , 1 , p} ( m ) & ( 7 ) \\ {β}_{k , 1 , p} ( m ) = {e}^{- j2π \frac{pm}{N}} {\sum }_{n = N + D - v + 1}^{N + D - p - 1} [ w ( n ) - 1 ] {e}^{j2π \frac{( m - k ) ( n + p - D )}{N}} \\ \text{for} D - \frac{L}{2} < p \leq D & ( 8 ) \\ {ITI}_{p} = {h}_{p} \frac{1}{N} {\sum }_{m \neq k} {X}_{i} ( m ) {β}_{k , 2 , p} ( m ) & ( 9 ) \\ {ISI}_{p} = {h}_{p} \frac{1}{N} {h}_{p} {\sum }_{m ∀ subcarriers} {X}_{i + 1} ( m ) {e}^{jπ} {β}_{k , 2 , p} ( m ) & ( 10 ) \\ {β}_{k , 2 , p} ( m ) = {e}^{- j2π \frac{pm}{N}} {\sum }_{n = D - p}^{\frac{L}{2} - 1} [ w ( n ) - 1 ] {e}^{j2π \frac{( m - k ) ( n + p - D )}{N}} & ( 11 )\end{matrix}$$

where index m refers to interfering subcarriers, Xᵢ(m) is the m^{th} subcarrier's modulation symbol of the current OFDM symbol and X_{i+1,}(m) and Xᵢ₋₁ are the m^{th} subcarrier's modulation symbol of the adjacent OFDM symbol.

In order to cancel the interference induced by the IEEE 802.11a suggested window function, the coefficients β_{k,1,p} (m) and β_{k,2,p} (m) for a finite set of channel path delays are determined using equations (8) and (11) and can be stored in a look-up table and applied to regenerated subcarrier modulation symbols Xᵢ(m), m≠k, Xᵢ₋₁(m), Xᵢ₊₁(m) of the current, previous and next OFDM symbols, respectively, which are regenerated from the decoder 430 output bits after re-encoding (using encoder 435), interleaving and mapping (using interleaving and mapping module 435).

Accordingly, the interference for the k^{th} subcarrier is calculated as

$${I}_{tot} = {I}_{tot , 1} + {I}_{tot , 2} \\ {I}_{tot} = \frac{1}{N} \{ {\sum }_{p = 0}^{D - \frac{L}{2}} {h}_{p} {\sum }_{m \neq k} {β}_{k , 1 , p} ( m ) [ {X}_{i} ( m ) + {X}_{i - 1} ( m ) {e}^{- j2π ( \frac{Dm}{N} - \frac{1}{2} )} ] + {β}_{k , 1 , p} ( k ) {X}_{i - 1} ( k ) {e}^{- j2π ( \frac{Dk}{N} - \frac{1}{2} )} \} + \frac{1}{N} \{ {\sum }_{p = D - \frac{L}{2} + 1}^{D} {h}_{p} {\sum }_{m \neq k} {β}_{k , 2 , p} ( m ) [ {X}_{i} ( m ) + {X}_{i + 1} ( m ) {e}^{j π} ] + {β}_{k , 2 , p} ( k ) {X}_{i + 1} ( k ) {e}^{jπ} \} \qquad ( 14 )$$

Based on this equation (14), canceling the window-induced interference caused by applying w(n) to the transmitted signal requires knowledge of the channel impulse response hₚ, which can be estimated in the CIR estimator 455 from a training sequence via taking the IFFT of the estimated channel frequency response. Alternatively, the channel impulse response may be estimated from the cross correlation of a known long training sequence with the received sequence. In this embodiment, the CIR and stored coefficients, β_{k,1,p} (m) and β_{k,2,p} (m) are used to weight the regenerated Xᵢ(m), m≠k, Xᵢ₋₁(m)and Xᵢ₊₁(m). Moreover, in a further implementation, the CIR coefficients are compared to a predetermined threshold such that only those exceeding the threshold are used to calculate the interference. In this way, a trade-off between computation complexity and accuracy of the interference calculation can be attained.

As can be further seen from equation (14), canceling the interference due to the IEEE 802.11a window is problematic in that it requires regenerated subcarrier modulation symbols from the subsequent, (i+1)^{th}, OFDM symbol (i.e., non-causal). Furthermore, all adjacent symbols contribute mutual ISI to each other. That is, OFDM symbols i−1 and i mutually interfere with each other as do symbols i and i+1. Therefore, a joint solution is necessary for cancellation of interference from adjacent OFDM symbols. The problem of non-causality and mutual interference can be overcome by using a modified IEEE 802.11a window function being shifted in time. This modified window function w(n) is defined by the following equation (15):

$$\begin{matrix}w ( n ) = {sin}^{2} [ \frac{π}{2} ( \frac{1}{2} + \frac{n - \frac{L}{2}}{L} ) ] ; 0 < n < L \\ = 1 ; L \leq n < ( N + D ) \\ = {sin}^{2} [ \frac{π}{2} ( \frac{1}{2} - \frac{( n - \frac{L}{2} - ( N + D ) )}{L} ) ] ; ( N + D ) \leq n < ( N + D ) + L ,\end{matrix} \qquad ( 15 )$$

where N is the number FFT samples, D is the number of cyclic prefix samples, L is the number of samples comprising the transition region of the window, and n is the sample index.

FIG. 6 illustrates a sequence of OFDM symbols 610 comprising a current (Xᵢ), a previously transmitted (Xᵢ₋₁) and a subsequently transmitted (Xᵢ₊₁) OFDM symbol, wherein w(n) of equation 15 is applied to the signal samples 620. As shown, the modified window function is the same as the IEEE 802.11a window function shifted left by L/2 samples, where L is the window function transition sample length. As a result, OFDM symbol i suffers interference from symbol i−1 (the previously transmitted symbol) alone. Also, symbol i does not interfere with symbol i−1. That is, using the modified window the (i−1)^{th} symbol generates ISI for symbol i only, and only this ISI requires cancellation from the received signal. It should be noted that any window can be modified by shifting it in time far enough into the current symbol so as to not bring weighted samples of the next symbol into the time of the current sample.

Without, interference cancellation, this window (as defined by equation (15)), on average, results in more interference than the IEEE 802.11a window for channels with maximum path delay p<L since all such paths contribute interference from one or more of the last L samples of the FFT sample window. However, when used with the interference cancellation methods in accordance with the teachings herein, the modified window function will provide higher C/I, since all of the ISI due to the (i−1)^{th} OFDM symbol can be removed from the i^{th} symbol along with the ITI.

The maximum average achievable C/I using the modified window function is defined by the following equation (16):

$${[ C / I ]}_{k} = \frac{{\sum }_{p = 0}^{D} E {\{ {\vert {h}_{p} \vert}^{2} \} [ N + {γ}_{1 , p} ]}^{2}}{{\sum }_{p = 0}^{D} E \{ {\vert {h}_{p} \vert}^{2} \} [ 2 {\sum }_{m \neq k} {\vert {β}_{k , 1 , p} ( m ) \vert}^{2} + {γ}_{1 , p}^{2} ]} \\ {γ}_{1 , p} = {\sum }_{n = N + D - v + 1}^{N - p + D - 1} [ w ( n + \frac{L}{2} ) - 1 ] ; \\ v = L + δ ( L ) ; \\ {\vert {β}_{k , 1 , p} ( m ) \vert}^{2} = {[ {\sum }_{n = N + D - v + 1}^{N + D - p - 1} [ w ( n + \frac{L}{2} ) - 1 ] cos ( 2 π \frac{( m - k ) ( n + p - D )}{N} ) ]}^{2} + {[ {\sum }_{n = N + D - v + 1}^{N + D - p - 1} [ w ( n + \frac{L}{2} ) - 1 ] sin ( 2 π \frac{( m - k ) ( n + p - D )}{N} ) ]}^{2} \qquad ( 16 )$$

Accordingly, the interference for the modified window is now,

$$\begin{matrix}{I}_{tot} = {I}_{tot , 1} \\ \text{where} & ( 17 ) \\ {I}_{tot , 1} = {\sum }_{p = 0}^{D} {ITI}_{p} + {\sum }_{p = 0}^{D} {ISI}_{p} \\ \text{and for} 0 \leq p \leq D & ( 18 ) \\ {ITI}_{p} = \frac{1}{N} {h}_{p} {\sum }_{m \neq k} {X}_{i} ( m ) {β}_{k , 1 , p} ( m ) & ( 19 ) \\ {ISI}_{p} = \frac{1}{N} {h}_{p} {\sum }_{m ∀ subcarriers s} {X}_{i - 1} ( m ) {e}^{- j2π ( \frac{Dm}{N} - \frac{1}{2} )} {β}_{k , 1 , p} ( m ) & ( 20 ) \\ {β}_{k , 1 , p} ( m ) = {e}^{- j2π \frac{pm}{N}} {\sum }_{n = N + D - v + 1}^{N + D - p - 1} [ w ( n - p + D ) - 1 ] {e}^{j2π \frac{( m - k ) ( n + p - d )}{N}} & ( 21 )\end{matrix}$$

Note that storage for the coefficients β_{k,1,p} (m) is needed only for a finite set of channel path delays based on equation 21. These are then applied only to the Xᵢ(m), m≠k, and Xᵢ₋₁(m) of the current and previous OFDM symbols, respectively, which have been regenerated from the decoder output bits after re-encoding and symbol mapping. The interference is then calculated in accordance with the following equation (22):

$${I}_{tot} = \frac{1}{N} \{ {\sum }_{p = 0}^{D} {h}_{p} {\sum }_{m \neq k} {β}_{k , 1 , p} ( m ) [ {X}_{i} ( m ) + {X}_{i - 1} ( m ) {e}^{- j2π ( \frac{Dm}{N} - \frac{1}{2} )} ] + {β}_{k , 1 , p} ( k ) {X}_{i - 1} ( k ) {e}^{- j2π ( \frac{Dk}{N} - \frac{1}{2} )} \}$$

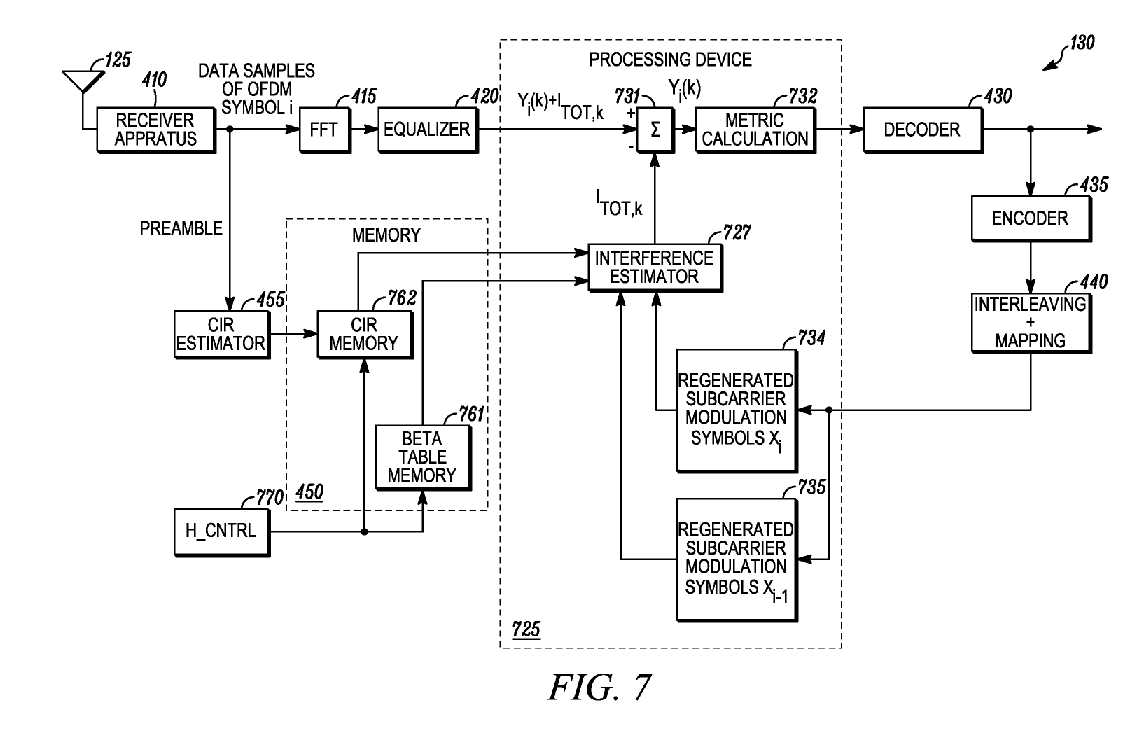

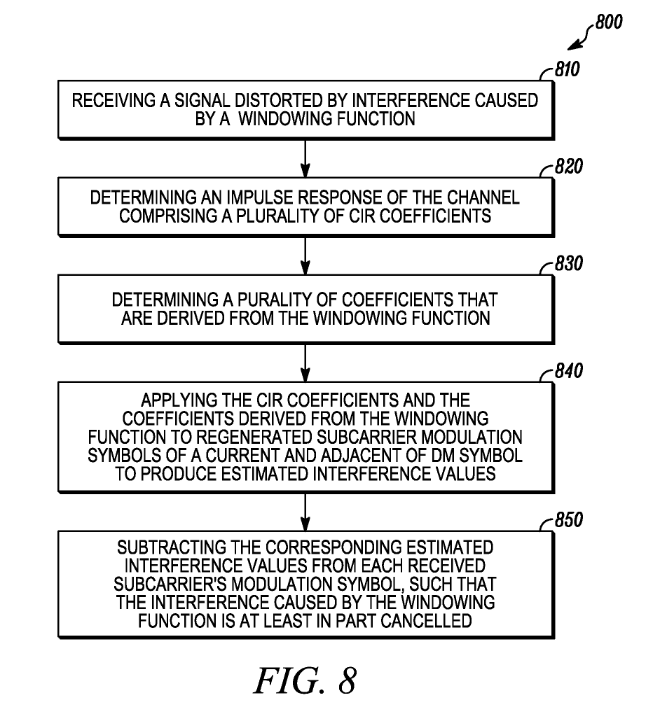

Window-induced interference cancellation, where the w(n) is defined by equation (15) is illustrated by reference to FIGS. 7 and 8. FIG. 7 illustrates a block diagram of those portions of receiving device 130 used in receiving an RF signal transmitted by a transmitting device (e.g., an RF signal comprising OFDM symbols Xᵢ₋₁, Xᵢ and Xᵢ₊₁ in the symbol sequence 610 that is transmitted by device 110) and processing the signal to obtain the digitized data bits included therein. However, the embodiment of receiving device 130 illustrated in FIG. 7 is configured for interference cancellation, where the transmitting device uses a w(n) as defined in equation (15). Accordingly, FIG. 7 comprises the identical elements as illustrated in FIG. 4 of the antenna 125, the receiver apparatus 410, the FFT processing module 415, the equalizer 420, the FEC decoder 430, the encoder 435, the interleaving and mapping processing module 440, the CIR estimator 455 and the memory 450 storing CIR coefficients 762 and β coefficients 761. Moreover, receiving device 130 further comprises a processing device 725 including an interference estimator 727 and a metric calculation module 732, with the metric calculation module (732) being used to generate code bit metrics for input to the decoder, the metrics typically being a likelihood or likelihood ratio value. Device 130 is further shown as comprising a control (H_CNTRL) block 770 that controls the flow of selected CIR 762 and β 761 coefficients from memory 450.

Turning now to FIG. 8, a flow diagram illustrating a method for interference cancellation from a signal received into device 130 of FIG. 7 is shown and indicated at 800, in accordance with embodiments of the invention. At step 810, device 130 receives an RF signal at antenna 125 that is distorted by ISI and ITI interference caused by the windowing function defined in equation (15). The received signal is processed by the receiver apparatus 410, FFT 415 and equalizer 420 in the manner described above by reference to FIG. 4 to generate at the output of the equalizer 420 subcarrier modulation symbols with added ISI and ITI caused by w(n). At step 820, device 130 determines the impulse response of the channel using CIR estimator 455 in a manner described above with respect to FIG. 4 and selects corresponding CIR coefficients 762 from memory 450 under the control of block 770, wherein the CIR coefficients characterize the determined response of the channel.

At step 830, device 130 determines coefficients that are derived from the windowing function, w(n). In this embodiment, determining the coefficients comprises selecting the proper β coefficients associated with a given path length, subcarrier and modulation scheme, under the control of block 770. At step 840, the interference estimator 727 applies the CIR coefficients and the β coefficients to regenerated subcarrier modulation symbols 734, 735 for the current OFDM symbol Xᵢ and the previously transmitted OFDM symbol Xᵢ₋₁, respectively, in OFDM symbol sequence 610 to produce estimated interference values I_{tot,k} for the kth subcarrier, wherein values I_{tot,k} are determined using equation (22) above.

Subcarrier modulation symbols for all but the current subcarrier k in the current OFDM symbol are used by the interference estimator 727 to estimate the ITI, which is distorting a current subcarrier modulation symbol for subcarrier k of the current OFDM symbol. Subcarrier modulation symbols for all of the subcarriers in the previously transmitted OFDM symbol are used by the interference estimator 727 to estimate the ISI, which is distorting the current subcarrier modulation symbol for subcarrier k of the current OFDM symbol. The regenerated subcarrier modulation symbols 734 and 735 are generated by encoder 435 and interleaving and mapping module 440 processing the decoded bits output from the decoder 430. Finally, the processing device 725 of receiving device 130 (at step 850) subtracts a corresponding interference value (e.g., I_{tot,k}) from each received subcarrier modulation symbol distorted by the window-induced interference, (e.g., Yᵢ+I_{TOT}), such that the interference caused by the windowing function is at least in part cancelled.

In the foregoing specification, specific embodiments of the present invention have been described. However, one of ordinary skill in the art will appreciate that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “ including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. The terms “a” and “an” are defined as one or more, unless explicitly stated otherwise herein.

What is claimed is:

1. A method for interference cancellation in a received signal, the method comprising the steps of:
receiving a signal that is distorted by interference caused by a windowing function applied to the signal prior to it being transmitted;
determining a plurality of coefficients that are derived from the windowing function; and
applying the coefficients to the received signal to cancel at least a portion of the interference from the received signal.

2. The method of claim 1, wherein the interference comprises at least one of inter-symbol and inter-tone interference.

3. The method of claim 1, wherein the received signal comprises a plurality of OFDM symbols.

4. The method of claim 3, wherein the windowing function is defined as:
$$\begin{matrix}w ( n ) = {sin}^{2} [ \frac{π}{2} ( \frac{1}{2} + \frac{n}{L} ) ] ; - \frac{L}{2} < n < \frac{L}{2} \\ = 1 ; \frac{L}{2} \leq n < ( N + D ) - \frac{L}{2} \\ = {sin}^{2} [ \frac{π}{2} ( \frac{1}{2} - \frac{( n - ( N + D ) )}{L} ) ] ; ( N + D ) - \frac{L}{2} \leq n < ( N + D ) + \frac{L}{2} ,\end{matrix}$$
where N is the number FFT samples, D is the number of cyclic prefix samples, L is the number of samples comprising the transition region of the window, and n is a sample index.

5. The method of claim 3, wherein the windowing function is defined as:
$$\begin{matrix}w ( n ) = {sin}^{2} [ \frac{π}{2} ( \frac{1}{2} + \frac{n - \frac{L}{2}}{L} ) ] ; 0 < n < L \\ = 1 ; L \leq n < ( N + D ) \\ = {sin}^{2} [ \frac{π}{2} ( \frac{1}{2} - \frac{( n - \frac{L}{2} ( N + D ) )}{L} ) ] ; ( N + D ) \leq n < ( N + D ) + L ,\end{matrix}$$
where N is the number FFT samples, D is the number of cyclic prefix samples, L is the number of samples comprising the transition region of the window, and n is the sample index.

6. The method of claim 3, wherein the step of applying the coefficients to the received signal comprises the steps of:
decoding the plurality of OFDM symbols to generate decoded bits;
processing the decoded bits to provide regenerated subcarrier modulation symbols for each of the plurality of OFDM symbols;
modifying the regenerated subcarrier modulation symbols with the coefficients to estimate the interference; and
subtracting the interference from each subcarrier's modulation symbol of a current OFDM symbol.

7. The method of claim 6, wherein the plurality of coefficients further comprises a plurality of channel impulse response coefficients.

8. A method for interference cancellation in an Orthogonal Frequency Division Multiplexing (OFDM) communication system, the method comprising steps of:
receiving, over a channel, a signal that is distorted by interference caused by a windowing function applied to the signal prior to it being transmitted, the signal comprising a current and at least one adjacent OFDM symbol;
determining an impulse response of the channel comprising a plurality of channel impulse response (CIR) coefficients;
determining a plurality of coefficients that are derived from the windowing function;
applying the CIR coefficients and the coefficients derived from the windowing function to a plurality of regenerated subcarrier modulation symbols for the current and adjacent OFDM symbols to produce an estimated interference value for each received subcarrier's modulation symbol of the current OFDM symbol; and
subtracting the corresponding estimated interference value from each received subcarrier's modulation symbol of the current OFDM symbol, such that the interference caused by the windowing function is at least in part cancelled.

9. The method of claim 8, wherein the windowing function is defined as:
$$\begin{matrix}w ( n ) = {sin}^{2} [ \frac{π}{2} ( \frac{1}{2} + \frac{n}{L} ) ] ; - \frac{L}{2} < n < \frac{L}{2} \\ = 1 ; \frac{L}{2} \leq n < ( N + D ) - \frac{L}{2} \\ = {sin}^{2} [ \frac{π}{2} ( \frac{1}{2} - \frac{( n - ( N + D ) )}{L} ) ] ; ( N + D ) - \frac{L}{2} \leq n < ( N + D ) + \frac{L}{2} ,\end{matrix}$$
where N is the number FFT samples, D is the number of cyclic prefix samples, L is the number of samples comprising the transition region of the window, and n is a sample index.

10. The method of claim 8, wherein the windowing function is defined as:
$$\begin{matrix}w ( n ) = {sin}^{2} [ \frac{π}{2} ( \frac{1}{2} + \frac{n - \frac{L}{2}}{L} ) ] ; 0 < n < L \\ = 1 ; L \leq n < ( N + D ) \\ = {sin}^{2} [ \frac{π}{2} ( \frac{1}{2} - \frac{( n - \frac{L}{2} ( N + D ) )}{L} ) ] ; ( N + D ) - \frac{L}{2} \leq n < ( N + D ) + L ,\end{matrix}$$
where N is the number FFT samples, D is the number of cyclic prefix samples, L is the number of samples comprising the transition region of the window, and n is the sample index.

11. The method of claim 8, wherein the interference is at least one of inter-symbol interference and inter-tone interference.

12. The method of claim 8, wherein each of the CIR coefficients that are applied to the regenerated subcarrier modulation symbols exceeds a predetermined threshold.

13. Apparatus for interference cancellation in a received signal comprising:
receiver apparatus receiving a signal distorted by interference caused by a windowing function applied to the signal prior to it being transmitted; and
a processing device coupled to the receiver apparatus, the processing device,
obtaining a plurality of coefficients that are derived from the windowing function and that are based on an impulse response of a channel over which the signal was received, and
applying the coefficients to the received signal to cancel at least a portion of the interference from the received signal.

14. The apparatus of claim 13 further comprising a storage device coupled to the processing device and storing the plurality of coefficients.

15. The apparatus of claim 13, wherein the apparatus is operated in accordance with Institute of Electrical and Electronics Engineers 802.11a and 802.16 wireless communications standards.

16. The apparatus of claim 15, wherein the windowing function is a windowing function suggested for use in one of the 802.11a and 802.16 standards.

17. The apparatus of claim 15, wherein:
the received signal comprises a plurality of OFDM symbols;
the windowing function is a windowing function suggested for use in one of the 802.11a and 802.16 standards, which is shifted in time; and
the coefficients are applied to a plurality of regenerated subcarrier modulation symbols for a current and prior adjacent OFDM symbol in the received signal to cancel the at least a portion of interference from the received signal.

18. The apparatus of claim 13 further comprising transmitter apparatus coupled to a processing device, wherein the apparatus is included in a wireless communication device.
